(19) United States
(12) Patent Application Publication
(10) Pub. No.: US 2024/0112237 A1
(43) Pub. Date: Apr. 4, 2024

(54) USING DECISION TREES TO PROVIDE A GUIDED E-COMMERCE EXPERIENCE

(71) Applicant: AT&T Intellectual Property I, L.P., Atlanta, GA (US)

(72) Inventors: Kapil Gupta, Flower Mound, TX (US); Karthik Viswanathan, Irving, TX (US); Sundara Subramanian Athinarayanan Sundaram Mohan Narayanan, McKinney, TX (US); Mary Narisetti, Johns Creek, GA (US)

(21) Appl. No.: 17/936,835

(22) Filed: Sep. 29, 2022

(51) Int. Cl. G06Q 30/06

(52) U.S. Cl. CPC G06Q 30/0631; G06Q 30/0627

(57) ABSTRACT

A method includes receiving a signal that a user wishes to purchase a product, initializing a decision tree to collect information from the user, presenting a first query to the user, where the first query is selected for presentation based on the decision tree, receiving, in response to the first query, a first user input comprising at least one of: a feature preference or a budget constraint related to the product, presenting a subsequent query to the user, where the subsequent query is selected for presentation based on the first user input and the decision tree, receiving, in response to the subsequent query, a subsequent user input comprising at least one of: a feature preference or a budget constraint related to the product, and presenting information about a recommended product that is identified by using the first user input and the subsequent user input to traverse the decision tree.

The present disclosure relates generally to e-commerce, and relates more particularly to devices, non-transitory computer-readable media, and methods for using decision trees to provide a guided e-commerce experience.

### BACKGROUND

Electronic commerce (or “e-commerce”) involves the buying and selling of products and services through the Internet, as opposed to in brick and mortar retail locations. E-commerce therefore allows consumers to purchase products and services at any time and from anywhere. Technological advancements, as well as the lockdowns initiated during the COVID-19 pandemic, have contributed to unprecedented growth in e-commerce, with yearly sales through e-commerce markets now accounting for trillions of dollars. Moreover, recent research has shown that even when retail transactions are conducted offline, e-commerce often shapes the manner in which people shop for products and services. For instance, consumers may research products and services online before making an offline purchase.

### SUMMARY

The present disclosure broadly discloses methods, computer-readable media, and systems for using decision trees to provide a guided e-commerce experience. In one example, a method performed by a processing system including at least one processor includes receiving a signal indicating that a user wishes to initiate a purchase of a product, initializing a decision tree to collect information from the user related to the purchase of the product, presenting, via a user interface, a first query to the user, where the first query is selected for presentation based on the decision tree, receiving, via the user interface in response to the first query, a first user input comprising at least one of: a feature preference related to the product or a budget constraint related to the product, presenting, via the user interface, a subsequent query to the user, where the subsequent query is selected for presentation based on the first user input and the decision tree, receiving, via the user interface in response to the subsequent query, a subsequent user input comprising at least one of: a feature preference related to the product or a budget constraint related to the product, where the subsequent user input is different from the first user input, and presenting information about a recommended product that is identified by using the first user input and the subsequent user input to traverse the decision tree, to the user via the user interface.

In another example, a non-transitory computer-readable medium may store instructions which, when executed by a processing system including at least one processor, cause the processing system to perform operations. The operations may include receiving a signal indicating that a user wishes to initiate a purchase of a product, initializing a decision tree to collect information from the user related to the purchase of the product, presenting, via a user interface, a first query to the user, where the first query is selected for presentation based on the decision tree, receiving, via the user interface in response to the first query, a first user input comprising at least one of: a feature preference related to the product or a budget constraint related to the product, presenting, via the user interface, a subsequent query to the user, where the subsequent query is selected for presentation based on the first user input and the decision tree, receiving, via the user interface in response to the subsequent query, a subsequent user input comprising at least one of: a feature preference related to the product or a budget constraint related to the product, where the subsequent user input is different from the first user input, and presenting information about a recommended product that is identified by using the first user input and the subsequent user input to traverse the decision tree, to the user via the user interface.

In another example, a device may include a processing system including at least one processor and a non-transitory computer-readable medium storing instructions which, when executed by the processing system, cause the processing system to perform operations. The operations may include receiving a signal indicating that a user wishes to initiate a purchase of a product, initializing a decision tree to collect information from the user related to the purchase of the product, presenting, via a user interface, a first query to the user, where the first query is selected for presentation based on the decision tree, receiving, via the user interface in response to the first query, a first user input comprising at least one of: a feature preference related to the product or a budget constraint related to the product, presenting, via the user interface, a subsequent query to the user, where the subsequent query is selected for presentation based on the first user input and the decision tree, receiving, via the user interface in response to the subsequent query, a subsequent user input comprising at least one of: a feature preference related to the product or a budget constraint related to the product, where the subsequent user input is different from the first user input, and presenting information about a recommended product that is identified by using the first user input and the subsequent user input to traverse the decision tree, to the user via the user interface.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure use decision trees to provide a guided e-commerce experience;

FIG. 2 illustrates a flowchart of an example method for using decision trees to provide a guided e-commerce experience, in accordance with the present disclosure;

FIG. 3 illustrates a portion of an example decision tree;

FIG. 4 illustrates a plurality of user interface displays that may be displayed to a user in connection with the method of FIG. 2; and

FIG. 5 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for using decision trees to provide a guided e-commerce experience. Electronic commerce (or “e-commerce”) involves the buying and selling of products and services through the Internet, as opposed to in brick and mortar retail locations. E-commerce therefore allows consumers to purchase products and services at any time and from anywhere. Technological advancements, as well as the lockdowns initiated during the COVID-19 pandemic, have contributed to unprecedented growth in e-commerce, with yearly sales through e-commerce markets now accounting for trillions of dollars. Moreover, recent research has shown that even when retail transactions are conducted offline, e-commerce often shapes the manner in which people shop for products and services. For instance, consumers may research products and services online before making an offline purchase.

However, while e-commerce has in many ways simplified consumers' abilities to shop for products and services, it often lacks some of the advantages of shopping in person. For instance, every consumer's needs are unique. Some consumers may prefer to speak with human customer service representatives who can answer questions and help the consumers understand their needs and how different products or services may fit those needs. Although elements of these human interactions may be approximated through digital means (e.g., chatbots), this approximation may be costly and complicated. For instance, a digital product team may need to code every possible path of an interaction, making assumptions about consumer questions and behaviors.

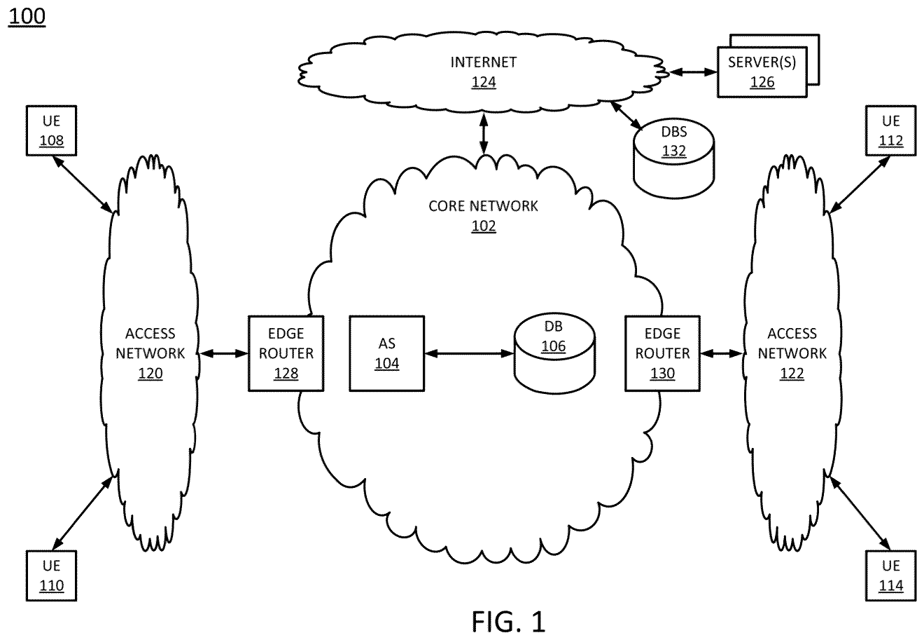

Examples of the present disclosure integrate front-end user interface (UI) templates with decision trees that dynamically drive a consumer interaction. That is, the decision tree can translate next actions for the front-end, without the need to code those next actions. This, in combination with natural language processing, provides a more natural user experience for the consumer and also allow for interactions to be changed or to take different paths without requiring the writing of additional code. Thus, more personalized and targeted interactions can be facilitated in order to help a consumer determine his or her needs, without the need for complex and costly coding on the seller side. Moreover, changes can be made to the decision trees without the need for coding experience or knowledge and can be translated into changes on the customer-facing site (e.g., user interface) in real time. Although examples of the present disclosure are discussed within the example context of telecommunications products and services, it will be understood that such examples could equally apply to the sale of other types of products and services over the Internet. These and other aspects of the present disclosure are discussed in greater detail below in connection with the examples of FIGS. 1-5.

To further aid in understanding the present disclosure, FIG. 1 illustrates an example system 100 in which examples of the present disclosure for using decision trees to provide a guided e-commerce experience may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, a database (DB) 106, and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

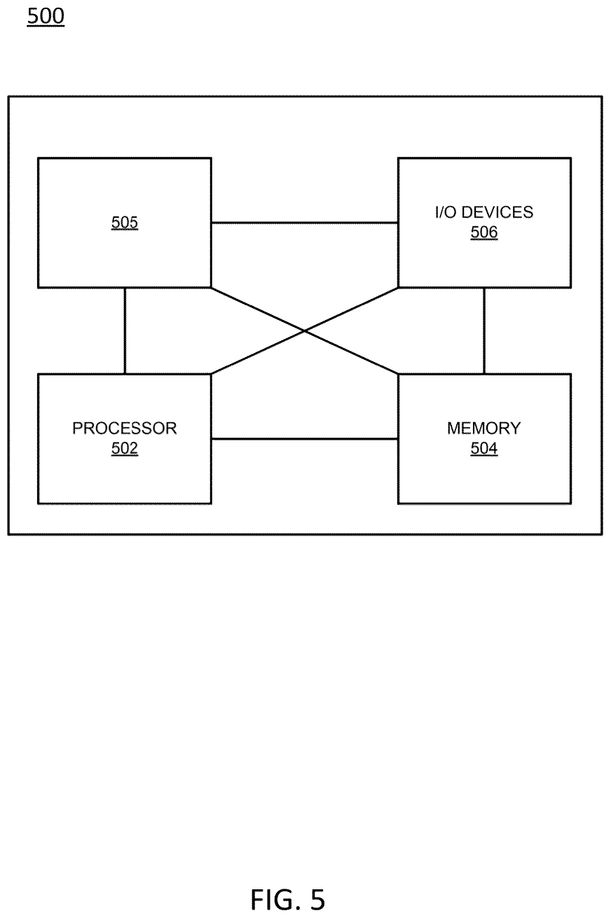

In one example, the access network 120 may be in communication with one or more user endpoint devices (UEs) 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device, such as computing system 500 depicted in FIG. 5, and may be configured as described below. For example, the user endpoint devices 108, 110, 112, and 114 may each comprise a mobile device, a cellular smart phone, a gaming console, a set top box, a laptop computer, a tablet computer, a desktop computer, an application server, a bank or cluster of such devices, and the like. In one example, any one of the user endpoint devices 108, 110, 112, and 114 may be operable by a human user to browse an e-commerce web site for the purposes of researching, selecting, and purchasing products and services via the Internet, as discussed in greater detail below.

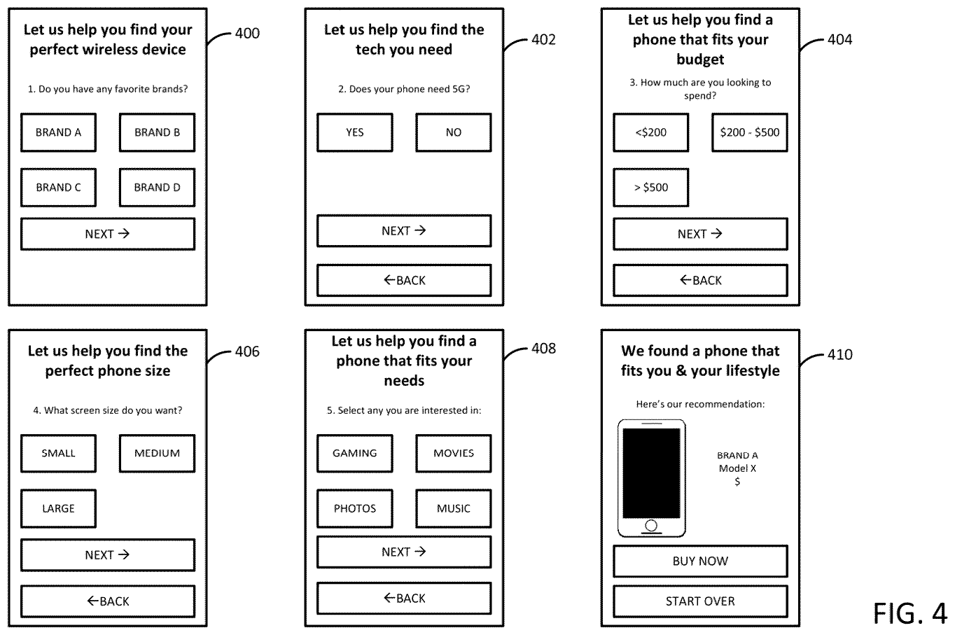

In one example, any one or more of the UEs 108-114 may communicate with a software application (e.g., a set of executable instructions) that provides a guided e-commerce experience, in accordance with the present disclosure. For instance, the software application may be hosted on the AS 104, which communicates with the UE 108-114 to request information from the user of the UE 108-114 and to present data about products and/or services responsive to the requested information. The AS 104 may present the data via a user interface that is displayed on the UE 108-114, such as the user interface illustrated in FIG. 4 and discussed in further detail below.

In accordance with the present disclosure, the AS 104 may be configured to provide one or more operations or functions in connection with examples of the present disclosure for using decision trees to provide a guided e-commerce experience, as described herein. The AS 104 may comprise one or more physical devices, e.g., one or more computing systems or servers, such as computing system 500 depicted in FIG. 5, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

In one example, the AS 104 may provide a guided e-commerce experience using a decision tree. For instance, the AS 104 may host a web site for a provider of a product or service, such as a retailer from whom users may make purchases through the Internet. As part of the web site, or as a separate service hosted in conjunction with the web site, the AS 104 may also host an application that helps a user to search the web site for a specific product or service that meets the user's feature preferences and/or budget constraints. In one example, the AS 104 may use a decision tree in conjunction with the user interface discussed below.

For instance, in one example, the AS 104 may display a user interface on the display of one of the UEs 108-114, as discussed above. The user interface may be designed to acquire information from a user of one of the UEs 108-114 related to the user's feature preferences and/or budget constraints for a product or service for which the user is searching. For instance, the user may be searching for a telecommunications service provider's web site for a mobile phone and a service plan for the mobile phone.

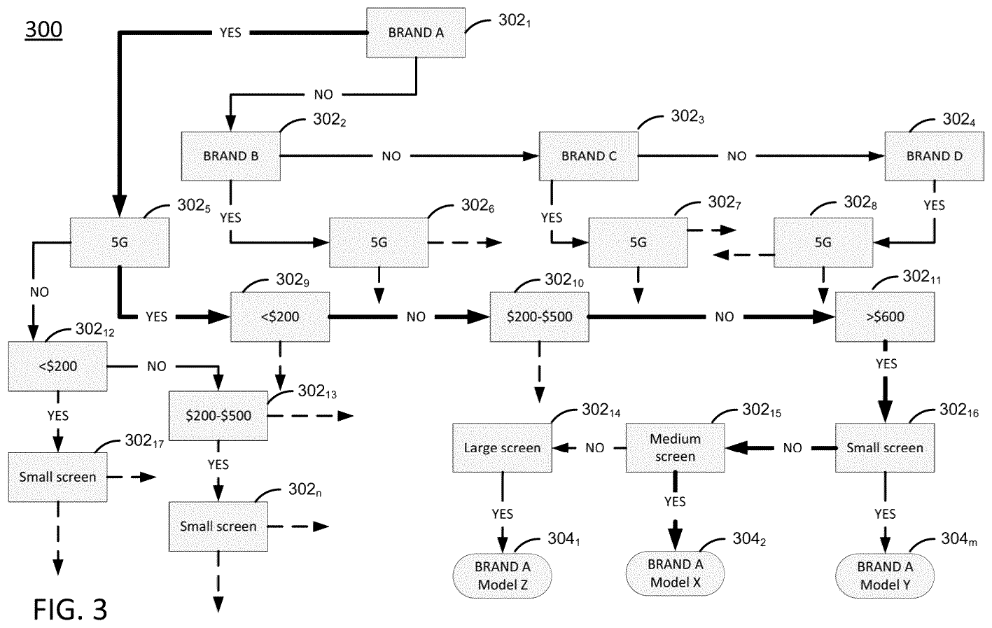

As the user provides inputs (e.g., feature preferences and/or budget constraints) via the user interface, the AS 104 may utilize these inputs to traverse a decision tree, such as the decision tree illustrated in FIG. 3 and discussed in further detail below. For instance, the decision tree may provide a first query to be presented to the user in order to launch the guided e-commerce experience. The AS 104 may then use the user's answer to that first query to traverse the decision tree and identify a subsequent query to be presented to the user. The user's answer to the subsequent query may be similarly used by the AS 104 to traverse the decision tree and identify further subsequent queries to be presented to the user, until one or more products or services matching the user's feature preferences and budget constraints are identified.

The DB 106 may store a plurality decision trees, where each decision tree of the plurality of decision trees may be configured to provide a different guided e-commerce experience for a different product or service. For instance, one decision tree could be configured to provide a guided e-commerce experience for purchasing a mobile phone, while another decision tree could provide a guided e-commerce experience for purchasing a computer or a car. The decision trees may be modified at any time (e.g., to add, delete, or change nodes and/or branches).

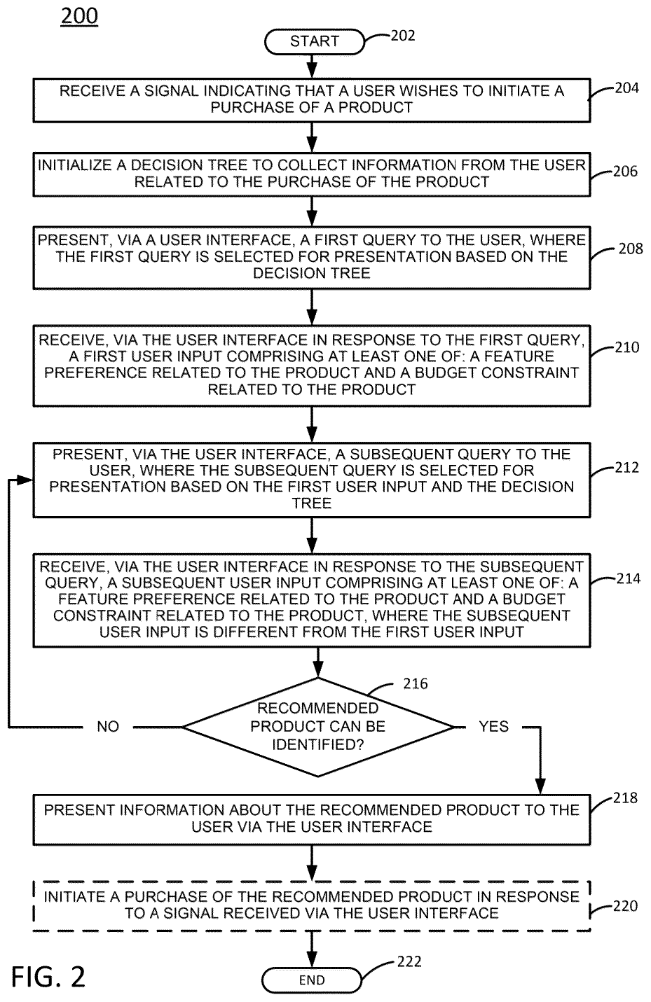

In one example, the DB 106 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for providing a guided e-commerce experience using decision trees as described herein. One example method for providing a guided e-commerce experience using decision trees is described in greater detail below in connection with FIG. 2.

In one example, one or more servers 126 and one or more databases (DBs) 132 may be accessible to user endpoint devices 108, 110, 112, and 114 via Internet 124 in general. The server(s) 126 and DBs 132 may operate in a manner similar to the AS 104 and DB 106, as described in further detail below.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

FIG. 2 illustrates a flowchart of an example method 200 for using decision trees to provide a guided e-commerce experience, in accordance with the present disclosure. In one example, steps, functions and/or operations of the method 200 may be performed by a device as illustrated in FIG. 1, e.g., AS 104 or any one or more components thereof. In another example, the steps, functions, or operations of method 200 may be performed by a computing device or system 500, and/or a processing system 502 as described in connection with FIG. 5 below. For instance, the computing device 500 may represent at least a portion of the AS 104 in accordance with the present disclosure. For illustrative purposes, the method 200 is described in greater detail below in connection with an example performed by a processing system, such as processing system 502.

The method 200 begins in step 202 and proceeds to step 204. In step 204, the processing system may receive a signal indicating that a user wishes to initiate a purchase of a product (or a service).

In one example, the signal may comprise an electronic signal received via a user interface that is displayed on the user's endpoint device. For instance, the user's endpoint device may be executing an application that assists the user in selecting a product or service for purchase. The application may comprise a standalone application installed on the endpoint device, or an application that is launched via a widget or similar mechanism from another application executing on the endpoint device, such as a web browser application. In one example, the widget may comprise a feature of a specific e-commerce web site that the user is viewing via the web browser application of the endpoint device. For instance, the user may be browsing an online store for a mobile phone of a service provider on the user's tablet computer.

In step 206, the processing system may initialize a decision tree to collect information from the user related to the purchase of the product. In one example, a decision tree comprises a tree-like model of decisions and the possible outcomes of those decisions. FIG. 3, for instance, illustrates a portion of an example decision tree 300. As illustrated, the decision tree 300 includes a plurality of decision nodes 302₁-302ₙ (hereinafter individually referred to as a “decision node 302” or collectively referred to as “decision nodes 302”) connected by a plurality of branches labeled either “YES” or “NO.” The decision nodes 302 represent decisions to be made (e.g., decisions concerning the product to be purchased), while the branches represent the possible decisions (e.g., yes or no) that can be made at a decision node 302. Collectively, a subset of the decision nodes 302 connected by a subset of the branches represents a possible path that a decision process may take through the decision tree 300. Paths illustrated in dashed lines in FIG. 3 show where the example decision tree 300 has been truncated for space; the decision tree 300 may continue along those dashed line paths to other decision nodes 302 and/or branches which are not illustrated in FIG. 3.

As discussed above, each decision node 302 may comprise a decision to be made, where answering “YES” or “NO” to the decision will narrow down a list of possible outcomes. For instance, the example decision tree 300 is configured to select a mobile phone from among a plurality of possible mobile phone choices, where each decision to be made may relate to a mobile phone feature. In this case, a decision process may begin with a first decision node 302₁ of the decision tree 300 and may progress through subsequent decision nodes 302 based on whether the answer to a previous decision node 302 was “YES” or “NO.” Examples of some decisions that may be captured in the decision nodes 302 include the brand of mobile phone, whether the mobile phone requires 5G connectivity, the price range for the mobile phone, the screen size of the mobile phone, and/or other features. A plurality of outcome nodes 304₁-304ₘ (hereinafter individually referred to as an “outcome node 304” or collectively referred to as “outcome nodes 304”) may represent possible outcomes of different paths through the decision tree 300. In the example of FIG. 3, the possible outcomes may comprise different brands and models of mobile phones that may be recommended based on choices made with respect to the features described above.

As discussed above, in some examples, the decision tree may be one of a plurality of decision trees stored in a database, and the appropriate decision tree may be selected from the database based on the signal received in step 204. For instance, if the signal indicates that the user wishes to purchase a mobile phone, a decision tree specifically configured to help select a mobile phone from among a plurality of mobile phone selections may be initialized in step 206. The appropriate decision tree may be linked to or activated by selection of a specific item on a web site (e.g., clicking of a specific button or hyperlink). Alternatively, each decision tree of the plurality of decision trees may be associated with metadata, and a user query or action (e.g., clicking a button or hyperlink) may generate data that can be matched to the metadata associated with a particular decision tree.

In step 208, the processing system may present, via a user interface, a first query to the user, where the first query is selected for presentation based on the decision tree. In one example, the first query may be designed to obtain from the user information that will help the processing system to recommend a product or service to the user, or at least to narrow down the possible products or services that can be recommended to the user. For instance, the first query may be designed to determine one or more of the user's needs or preferences with respect to the product or service.

FIG. 4, for instance, illustrates a plurality of user interface displays 400-410 that may be displayed to a user in connection with the decision tree 300 of FIG. 3. The user interface displays 400-410 correspond to some decision nodes 302 or the decision tree 300. Thus, the example user interface displays 400-410 are designed to help a user select a mobile phone. For example, the user interface display 400 illustrates a first user interface display designed to determine whether the user has any favorite mobile phone brands. Thus, the first user interface display 400 may correspond to decision nodes 302₁-302₄ of the decision tree 300.

In one example, artificial intelligence techniques may be used to drive the text of the user interface displays 400-410, rather than a preset script. For instance, the processing system may understand the intent of a decision node 302 of the decision tree 300, and may use artificial intelligence techniques (e.g., machine learning techniques such as deep learning networks, long short-term memory techniques, or recurrent neural networks) and/or natural language processing in order to generate a text query designed to elicit an input from the user that will help to resolve the decision node 302 (e.g., to determine which branch of the decision tree 300 to follow from the decision node 302).

In step 210, the processing system may receive, via the user interface in response to the first query, a first user input comprising at least one of: a feature preference related to the product or a budget constraint related to the product. For instance, in one example, the user may make a selection via the user interface, e.g., by pressing a button related to the selection. As an example, the decision tree 300 illustrates a path highlighted in bold to show a series of selections that a user may make. The bolded path in FIG. 3 shows that the user has selected “BRAND A” as a favorite brand of mobile phone (first user input), where the brand of mobile phone may comprise a feature preference. This selection may narrow down the possible mobile phones that can be recommended to the user, as any branches of the decision tree 300 that relate to other brands of mobile phones (e.g., BRAND B, BRAND C, and BRAND D) may be ignored (or the paths continuing from decision nodes 302 related to those other brands may not be pursued).

In step 212, the processing system may present, via the user interface, a subsequent query to the user, where the subsequent query is selected for presentation based on the first user input and the decision tree. That is, a decision made with respect to one decision node 302 of the decision tree 300 may take a path that leads to another decision to be made. As an example, in FIG. 3, the user has selected BRAND A as a favorite mobile phone brand (first user input). Thus, the “YES” path leading out of decision node 302₁ is taken, leading to decision node 302₅, which inquiries as to whether the user wants a phone that has 5G connectivity. This continuation of the path is represented in user interface display 402 of FIG. 4.

In step 214, the processing system may receive, via the user interface in response to the subsequent query, a subsequent user input comprising at least one of: a feature preference related to the product or a budget constraint related to the product, where the subsequent user input is different from the first user input.

For instance, in one example, the user may make a selection via the user interface, e.g., by pressing a button related to the selection. The bolded path in FIG. 3 shows that the user has selected the need for 5G connectivity (subsequent user input), where 5G connectivity may comprise a feature preference. This selection may narrow down the possible mobile phones that can be recommended to the user, as any branches of the decision tree 300 that relate to BRAND A mobile phones that do not have 5G connectivity may be ignored (or the paths continuing from decision node 302₅ related to BRAND A phones without 5G connectivity may not be pursued).

In step 216, the processing system may determine whether the decision tree has enough information, based on the first user input and the subsequent user input, to identify a recommended product. In one example, the decision tree may have enough information to identify a recommended product when the first user input and subsequent user input have allowed the decision tree to narrow the possible products down to a single product that matches all feature preferences and budget constraints indicated in the first user input and subsequent user input. In another example, the decision tree may have enough information to identify a recommended product when the first user input and subsequent user input have allowed the decision tree to narrow the possible products down to no more than a threshold number of products (e.g., three products) that match all feature preferences and budget constraints indicated in the first user input and subsequent user input. However, if the number of products of the possible products exceeds the threshold number of products, then the processing system may determine that more information is needed in order to further narrow down the possible products.

If the processing system concludes in step 216 that the decision tree does not have enough information to identify the recommended product, then the method 200 may return to step 212, and the processing system may continue to utilize the decision tree to present subsequent queries to the user, based on subsequent user inputs.

For instance, FIG. 4 illustrates subsequent user interface displays 404-408 that are designed to obtain subsequent user inputs from the user. These subsequent user inputs may relate, for example, to budget constraints (e.g., does the user want to spend less than $200, between $200 and $500, or more than $500?), other product features such as screen size (e.g., small, medium, or large), and supported applications (e.g., gaming, movie streaming, photos, etc.). These subsequent user interface displays 404-408 may follow the bolded path through the decision tree 300 illustrated in FIG. 3, to ultimately recommend a BRAND A, Model X mobile phone in user interface display 410 (corresponding to outcome node 304₂).

If, however, the processing system concludes in step 216 that the decision tree does have enough information to identify the recommended product, then the method 200 may proceed to step 218. In step 218, the processing system may present information about the recommended product to the user via the user interface.

In one example, the processing system may identify, based on the decision tree and on the user inputs (e.g., first user input and any subsequent user inputs), a product that matches all of the feature preferences and budget constraints expressed by the user in the user inputs. For instance, the processing system may utilize the user inputs as a guide to traverse the decision nodes 302 of the decision tree 300, until the traversal arrives at an outcome node 304 (where the outcome node 304 corresponds to the product that matches all of the feature preferences and budget constraints expressed by the user in the user inputs). The product corresponding to the outcome node may comprise the recommended product, and the processing system may present information about the recommended product (e.g., photos, price, list of features, link to purchase, etc.) via the user interface (e.g., as illustrated in user interface display 410 of FIG. 4).

In optional step 220 (illustrated in phantom), the processing system may initiate a purchase of the recommended product in response to a signal received via the user interface. For instance, if the user interface provided a link for the user to initiate a purchase of the product (e.g., a “BUY NOW” button, as shown in user interface display 410 of FIG. 4), then the user may click on the link to initiate a purchase. The link may take the user to a web site belonging to the same entity to which the processing system and user interface belong (e.g., where the method 200 may be executed as an additional service on the web site of a telecommunications service provider that sells mobile phones and service plans), or the link may take the user to an external web site to facilitate the purchase (e.g., where the method 200 may be executed as a standalone service unaffiliated with any specific service provider or product source).

In another example, the processing system may direct the user to a brick and mortar retail location to complete the purchase of the recommended product. For instance, the processing may identify a retail location for a provider of the recommended product that is closest to the user's location, and may provide the address of and/or directions to the retail location along with an instruction to see a customer service representative at the retail location.

The method 200 may end in step 222.

Thus, examples of the present disclosure integrate front-end user interface (UI) templates with decision trees that dynamically drive a consumer interaction. That is, the decision tree can translate next actions for the front-end, without the need to code those next actions. This, in combination with natural language processing, provides a more natural user experience for the consumer and also allows for interactions to be changed or to take different paths without requiring the writing of additional code. Thus, more personalized and targeted interactions can be facilitated in order to help a consumer determine his or her needs, without the need for complex and costly coding on the seller side. Moreover, changes can be made to the decision trees without the need for coding experience or knowledge and can be translated into changes on the customer-facing site (e.g., user interface) in real time.

In some examples, rather than using a graphical user interface such as that illustrated in FIG. 4, the processing system may interact with the user via a different type of user interface, such as a conversational user interface (e.g., a “chatbot”).

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 5 depicts a high-level block diagram of a computing device or processing system specifically programmed to perform the functions described herein. As depicted in FIG. 5, the processing system 500 comprises one or more hardware processor elements 502 (e.g., a central processing unit (CPU), a microprocessor, or a multi-core processor), a memory 504 (e.g., random access memory (RAM) and/or read only memory (ROM)), a module 505 for using decision trees to provide a guided e-commerce experience, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 505 for using decision trees to provide a guided e-commerce experience (e.g., a software program comprising computer-executable instructions) can be loaded into memory 504 and executed by hardware processor element 502 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 505 for using decision trees to provide a guided e-commerce experience (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
receiving, by a processing system including at least one processor, a signal indicating that a user wishes to initiate a purchase of a product;
initializing, by the processing system, a decision tree to collect information from the user related to the purchase of the product;
presenting, by the processing system via a user interface, a first query to the user, where the first query is selected for presentation based on the decision tree;
receiving, by the processing system via the user interface in response to the first query, a first user input comprising at least one of: a feature preference related to the product or a budget constraint related to the product;
presenting, by the processing system via the user interface, a subsequent query to the user, where the subsequent query is selected for presentation based on the first user input and the decision tree;
receiving, by the processing system via the user interface in response to the subsequent query, a subsequent user input comprising at least one of: a feature preference related to the product or a budget constraint related to the product, where the subsequent user input is different from the first user input; and
presenting, by the processing system, information about a recommended product that is identified by using the first user input and the subsequent user input to traverse the decision tree, to the user via the user interface.

2. The method of claim 1, wherein the signal comprises an electronic signal received via the user interface that is displayed on an endpoint device of the user.

3. The method of claim 1, wherein the decision tree comprises:
a plurality of decision nodes, wherein each decision node of the plurality of decision nodes represents a decision to be made concerning the product; and
a plurality of branches connecting the plurality of decision nodes, wherein each branch of the plurality of branches represents a possible decision made at one decision node of the plurality of decision nodes.

4. The method of claim 3, wherein a combination of a subset of the plurality of decision nodes and a subset of the plurality of branches comprises a path through the decision tree.

5. The method of claim 4, wherein the path ends in an outcome node.

6. The method of claim 5, wherein the outcome node represents the recommended product.

7. The method of claim 1, wherein each of the first query and the subsequent query is designed to narrow down a set of possible products to identify the recommended product.

8. The method of claim 7, further comprising:
repeating the presenting the subsequent query and receiving the subsequent user input until the processing system is able to identify the recommended product using the decision tree.

9. The method of claim 7, further comprising:
repeating the presenting the subsequent query and receiving the subsequent user input until the processing system is able to identify no more than a threshold number of products including the recommended product.

10. The method of claim 1, further comprising:
initiating, by the processing system, a purchase of the recommended product in response to a second signal received via the user interface.

11. The method of claim 1, wherein the processing system uses an artificial intelligence technique to translate portions of the decision tree into the first query and the subsequent query.

12. The method of claim 1, wherein the user interface comprises a graphical user interface.

13. The method of claim 1, wherein the user interface comprises a chatbot user interface.

14. The method of claim 1, wherein the user interface is part of a web site provided by a seller of the product.

15. The method of claim 1, wherein the recommended product matches any feature preferences and budget constraints indicated in the first user input and the subsequent user input.

16. The method of claim 1, wherein a modification made to the decision tree is reflected in real time in the user interface.

17. The method of claim 1, wherein the decision tree comprises one decision tree of a plurality of decision trees, and each decision tree of the plurality of decision trees is configured to facilitate a selection of a different product or a different service.

18. The method of claim 1, wherein the decision tree is selected to be initialized from among a plurality of decision trees based on the signal.

19. A non-transitory computer-readable medium storing instructions which, when executed by a processing system including at least one processor, cause the processing system to perform operations, the operations comprising:
receiving a signal indicating that a user wishes to initiate a purchase of a product;
initializing a decision tree to collect information from the user related to the purchase of the product;
presenting, via a user interface, a first query to the user, where the first query is selected for presentation based on the decision tree;
receiving, via the user interface in response to the first query, a first user input comprising at least one of: a feature preference related to the product or a budget constraint related to the product;
presenting, via the user interface, a subsequent query to the user, where the subsequent query is selected for presentation based on the first user input and the decision tree;
receiving, via the user interface in response to the subsequent query, a subsequent user input comprising at least one of: a feature preference related to the product or a budget constraint related to the product, where the subsequent user input is different from the first user input; and
presenting information about a recommended product that is identified by using the first user input and the subsequent user input to traverse the decision tree, to the user via the user interface.

20. A device comprising:
a processing system including at least one processor; and
a non-transitory computer-readable medium storing instructions which, when executed by the processing system, cause the processing system to perform operations, the operations comprising:
receiving a signal indicating that a user wishes to initiate a purchase of a product;
initializing a decision tree to collect information from the user related to the purchase of the product;
presenting, via a user interface, a first query to the user, where the first query is selected for presentation based on the decision tree;
receiving, via the user interface in response to the first query, a first user input comprising at least one of: a feature preference related to the product or a budget constraint related to the product;
presenting, via the user interface, a subsequent query to the user, where the subsequent query is selected for presentation based on the first user input and the decision tree;
receiving, via the user interface in response to the subsequent query, a subsequent user input comprising at least one of: a feature preference related to the product or a budget constraint related to the product, where the subsequent user input is different from the first user input; and
presenting information about a recommended product that is identified by using the first user input and the subsequent user input to traverse the decision tree, to the user via the user interface.
